(19) United States
(12) Patent Application Publication
(10) Pub. No.: US 2009/0260734 A1
(43) Pub. Date: Oct. 22, 2009

(54) SAFETY WHEEL FOR VEHICLE

(76) Inventor: Eun-Ho Jo, Ansan (KR)

Correspondence Address: BOYLE FREDRICKSON S.C., 840 North Plankinton Avenue, MILWAUKEE, WI, 53203, US

(21) Appl. No.: 12/439,141

(22) PCT Filed: Jul. 27, 2007
(86) PCT No.: PCT/KR07/03637

§ 371 Date: Feb. 26, 2009

(30) Foreign Application Priority Data
Aug. 28, 2006 (KR) 10-2006-0081484

(51) Int. Cl. B60C 17/01; B60C 17/06

(52) U.S. Cl. 152/518; 152/520

(57) ABSTRACT

A safety wheel for a vehicle includes a rim having a body and a protrusion extending outward from an outer circumference of the body, and having a fastening groove; a first rubber layer wrapped on the protrusion of the rim; an air-filled tube disposed on the first rubber layer, and having a hollow body filled with compressed air therein; an outermost second rubber layer wrapped on the rim protrusion, the first rubber layer and the air-filled tube; and a rubber sheath wrapped on the rim protrusion, the first rubber layer, the air-filled tube and the second rubber layer. The safety wheel maintains pressure to support the weight of the vehicle, and even if the tire is blown out, prevents the vehicle from rocking and overturning due to inclination, as well as affords stability so that the vehicle can travel for a predetermined distance.

### BACKGROUND OF THE INVENTION

1. Field of the Invention

The present invention relates to a vehicle wheel, and more particularly, to a safety wheel for a vehicle, which can ensure that the vehicle can run for a predetermined distance without rocking even if a tire is blown out, and can prevent the tire from being blown out, thereby preventing a serious accident or casualties that would be caused by a blown tire.

2. Description of the Related Prior Art

In general, a vehicle wheel is assembled to a tire, which provides supporting force using compressed air injected therein, in order to act as a support of the fire. The vehicle wheel is used together with the tire in vehicles in order to enhance driving stability based on improved wheel-road contact as well as driving performance and steering performance based on light weight. In terms of the outward appearance, the vehicle wheel is designed to determine the overall atmosphere of a vehicle, such as an elegant appearance or a sporty look.

At present, tubeless tires are generally used as vehicle tires, and are mounted on the exterior of wheels.

However, as shown in FIG. 1, a tire 1 is mounted around a vehicle wheel 10 having a spool type rim 11, which is fixed to the exterior of a disk, which is fixedly connected to an axle. When the tire 1 is blown out when a vehicle is running, the tire becomes crushed as compressed air, which has supported the tire against the road, exits the tire, and it becomes difficult to drive the vehicle. If the vehicle is driven further in this state, the vehicle wheel 10 also becomes damaged under the weight of the vehicle.

Furthermore, if the tire is blown out during high speed travel, the vehicle abruptly inclines in the direction of the blown tire, so that the steering ability of the vehicle can be temporarily lost, and thus the vehicle can overturn, thereby causing a serious accident or casualties.

Because of these problems, the market is seeking a technology that enables a vehicle to safely run even in an emergency in which a tire is blown out while the vehicle is being driven.

### SUMMARY OF THE INVENTION

The present invention has been made to solve the foregoing problems with the prior art, and therefore an object of the present invention is to provide a safety wheel for a vehicle, which can prevent a tire from being blown out, thereby preventing a serious accident or casualties that would be caused by a blown tire, and by which the vehicle can run for a predetermined distance without rocking even if the tire is blown.

That is, the safety wheel of the present invention can ensure that the vehicle can run without rocking even if the tire is blown out, as well as enhance the driving stability of the vehicle by improving driving performance and steering performance.

As an aspect of the present invention for realizing the above object, there is provided a safety wheel for a vehicle, which includes a rim having a body and a protrusion extending outward from the outer circumference of the body, the protrusion having a fastening groove; a first rubber layer covered or wrapped on an outer portion of the protrusion of the rim to surround the protrusion; an air-filled tube disposed on an outer central portion of the first rubber layer, the air-filled tube having a hollow body filled with compressed air therein; a second rubber layer covered or wrapped on the protrusion of the rim, the first rubber layer and the air-filled tube; and a rubber sheath covered or wrapped on the protrusion of the rim, the first rubber layer, the air-filled tube and the second rubber layer, thereby forming an outermost layer.

According to the present invention, as set forth above, the safety wheel for a vehicle can maintain sufficient pressure to support the weight of the vehicle, and thus, even if the tire is blown out, can prevent the vehicle from rocking and overturning due to inclination, as well as afford stability so that the vehicle can run for a predetermined distance.

Furthermore, even if the tire is short of air pressure, the safety wheel for a vehicle of the present invention can structurally reinforce the air pressure to protect the tire and itself from being damaged, thereby preventing a serious accident or casualties due to a blown tire.

Moreover, the safety wheel for a vehicle of the present invention can stably support the tire in an unexpected incident during driving, such as sudden lane change, in order to prevent a tire from being blown out and the vehicle from skidding out by centrifugal force as well as provide more stable driving performance and steering ability even during high-speed driving.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a cross sectional view illustrating a conventional vehicle wheel;

FIG. 2 is a cutaway perspective view illustrating a safety wheel for a vehicle according to the invention;

FIG. 3 is a cross sectional view illustrating the safety wheel for a vehicle, assembled in the state as shown in FIG. 1;

FIGS. 4 to 9 are views illustrating a process of fabricating the safety wheel for a vehicle according to the present invention;

FIG. 10 is a cross sectional view illustrating an alternative to the air supply hose of the present invention; and

FIG. 11 is a cross sectional view illustrating the assembled state of another embodiment of the present invention.

### DETAILED DESCRIPTION OF THE PREFERRED EMBODIMENT

According to a preferred embodiment of the present invention, there is provided a safety wheel for a vehicle, which includes a rim having a body and a protrusion extending outward from the outer circumference of the body, the protrusion having a fastening groove; a first rubber layer covered or wrapped on an outer portion of the protrusion of the rim to surround the protrusion; an air-filled tube disposed on the outer central portion of the first rubber layer, the air-filled tube comprising a hollow body filled with compressed air therein; a second rubber layer covered or wrapped on the protrusion of the rim, the first rubber layer and the air-filled tube; and a rubber sheath covered or wrapped on the protrusion of the rim, the first rubber layer, the air-filled tube and the second rubber layer, thereby forming an outermost layer.

Preferably, the safety wheel further includes a gauze member interposed between the second rubber layer and the rubber sheath in order to enhance the pressure-maintaining function.

Preferably, each of the second rubber layer and the gauze member is made of a bulletproof material and has a bulletproofing function.

Preferably, the air-filled tube is a rubber tube with a thread or a wire embedded therein, or a metal tube made of a metal material.

Preferably, the safety wheel for a vehicle further includes an air pressure sensor mounted on the outer surface of the rubber sheath, thereby enabling a driver to determine the air pressure of the tire that contacts the rubber sheath.

The present invention will now be described more fully with reference to the accompanying drawings, in which preferred embodiments thereof are shown.

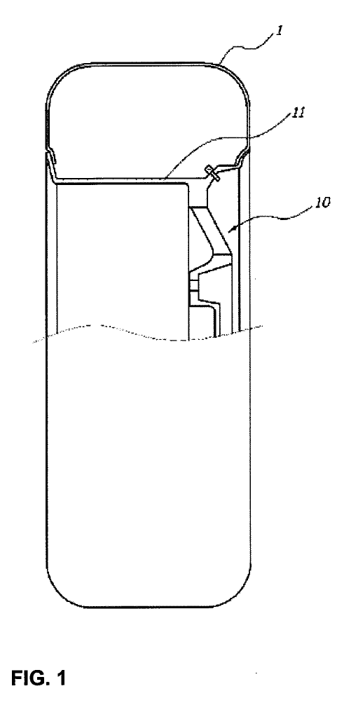

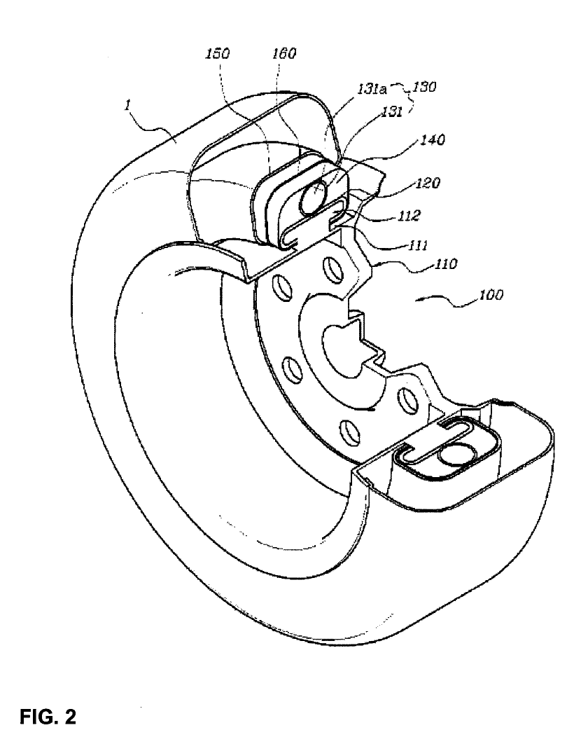

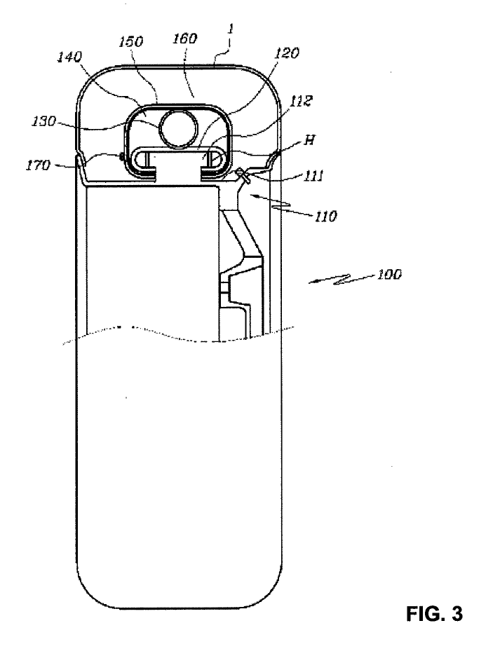

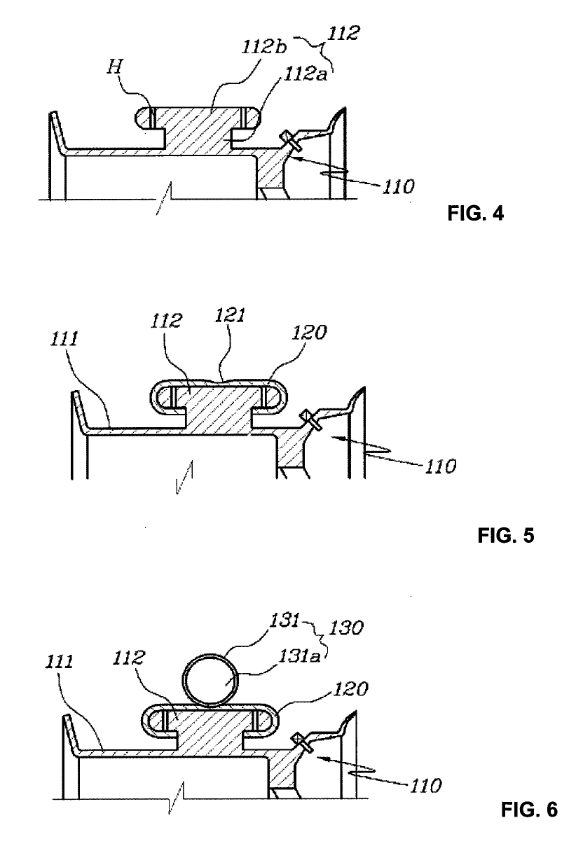

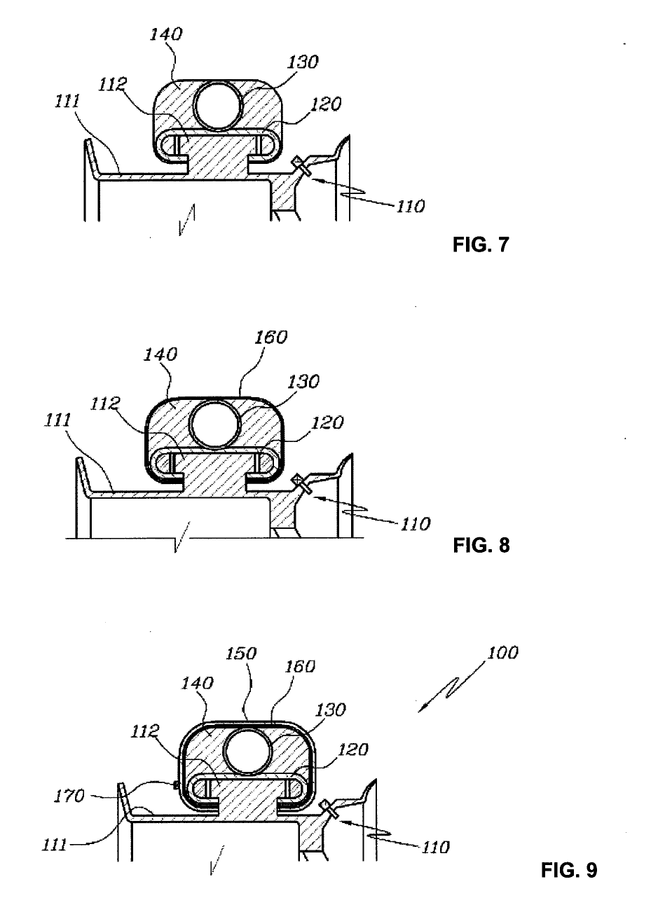

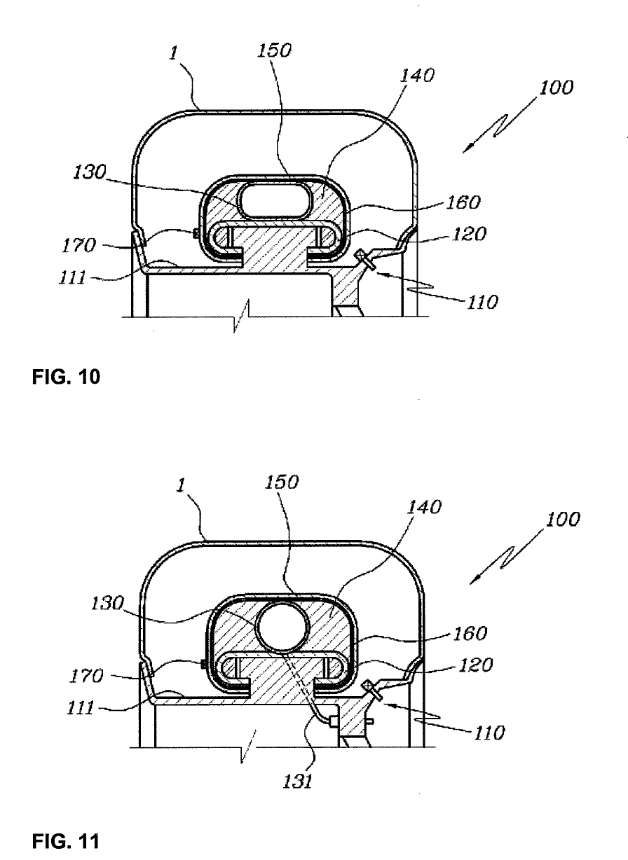

FIG. 2 is a cutaway perspective view illustrating a safety wheel for a vehicle according to the invention, FIG. 3 is a cross sectional view illustrating the safety wheel for a vehicle, assembled in the state as shown in FIG. 1, FIGS. 4 to 9 are views illustrating a process of fabricating the safety wheel for a vehicle according to the present invention, FIG. 10 is a cross sectional view illustrating an alternative to the air supply hose of the present invention, and FIG. 11 is a cross sectional view illustrating the assembled state of another embodiment of the present invention.

As shown in FIGS. 2 to 9, a safety wheel 100 for the vehicle of the present invention includes a rim 110, a first rubber layer 120, an air-filled tube 130, a second rubber layer 140 and a rubber sheath 150. The rim 110 has a spool type body 111 and a protrusion 112 extending outward from the outer surface of the body 111. The first rubber layer 120 is covered or wrapped on the exterior of the protrusion 112, thereby surrounding the same. The air-filled tube 130 has a hollow body 131, which is disposed in the outside center of the first rubber layer 120, and a hollow area 131a, in which the air is filled. The second rubber layer 140 is covered or wrapped on the safety wheel parts, starting from the protrusion 112 of the rim 110 to the air-filled tube 130. The rubber sheath 150 is covered or wrapped on the safety wheel parts, starting from the protrusion 112 of the rim 110 to the second rubber layer 140.

Preferably, a gauze member 160 is provided between the second rubber layer 140 and the rubber sheath 150, that is, worn or covered on the exterior of the second rubber layer 140, so that the pressure maintenance of the wheel 100 can be further enhanced. The gauze member 160 can be made of rigid threads, a wire, a metal member or the like.

In particular, the second rubber layer 140 and the gauze material 160 can be made of a bulletproof material in order to ensure bulletproof performance.

Preferably, the air-filled tube 130 is a rubber tube with rigid threads or a wire embedded therein, or a metal tube made of a metal material such as stainless steel. The air-filled tube 130 is also provided as a means for maintaining the volume as well as maintaining pressure, so that the safety wheel 100 can act as an emergency tire.

Although the air-filled tube 130 has been described as having a circular cross section, it can also have a rectangular cross section, formed by compressing the circular section, as shown in FIG. 6.

Also, it is preferable that an air pressure sensor 170 be mounted on the outer surface of the rubber sheath 150, which forms the outermost layer of the wheel 100. Using the air pressure sensor 170, the driver can identify the air pressure of the tire 1, which contacts the rubber sheath 150 when the tire 1 is coupled with the wheel 100. In addition, an electronic controller (not shown) can be provided to receive a radio signal transmitted by the air pressure sensor 170 based on the detection result, and to display the present air pressure of the tire 1, based on the received radio signal, in a predetermined position inside the vehicle, visible to the driver.

The protrusion 112 of the rim 110 has a vertical protrusion section 112a, which protrudes vertically outward from the central portion of the outer surface of the body 111, and a horizontal protrusion section 112b, which horizontally extends from the vertical protrusion section 112a. The horizontal protrusion section 112b has opposing protruding ends, each of which has a rounded outer shape.

Fastening holes H are formed in both edges of the horizontal protrusion section 112b, in order to help securely fix the first rubber layer 120 to the exterior of the protrusion 112.

Each of the first rubber layer 120, the second rubber layer 140 and the rubber sheath 150 is formed to a predetermined width with respect to the width of the rim 110, and has a rounded exterior in order to maintain a rounded tire shape. A seat 121 is recessed inward from the outer central portion of the first rubber layer 120, so that the air-filled tube 130 can be stably disposed and coupled with the first rubber layer 120.

The safety wheel 100 for a vehicle of the present invention as configured above can be provided in an integrated form, in which respective components are integrated together, or a detachable form, in which respective components can be assembled to and disassembled from each other.

In the case where the components are integrated together, the first rubber layer 120 is formed by applying a molten rubber resin on the protrusion 112 of the rim 110 through injection molding. The air-filled tube 130 is placed on the outside surface of the first rubber layer 120, the air is injected into the air-filled tube 130 to ensure the volume thereof, and then the air-filled tube 130 filled with compressed air is fixedly bonded to the first rubber layer 120. The second rubber layer 140 is formed by applying a molten rubber resin on the resultant structure by injection molding, the gauze member 160 is attached to the outer surface of the second rubber layer 140, and the rubber sheath 150 is formed by applying a molten rubber resin on the resultant structure by injection molding. Then, the air pressure sensor 170 is mounted on the outer surface of the rubber sheath 150.

In the case of the detachable components, the respective components from the rim 110 having the protrusion 112 to the rubber sheath 150 and the gauze member 160 are prepared by molding. The molded components are sequentially wrapped on or coupled to the protrusion 112 of the rim 110, so that the first rubber layer 120, the air-filled tube 130 filled with the compressed air, the second rubber layer 140, the gauze member 160 and the rubber sheath 150 are sequentially arranged and coupled together. Then, the air pressure sensor 170 is mounted on the outer surface of the rubber sheath 150.

In this case, each of the first rubber layer 120, the second rubber layer 140 and the rubber sheath 150 is an injection-molded article that is previously prepared, and the first rubber layer 120 has protrusions (not shown), which have a matching shape that fits into the fastening holes H of the protrusion 112.

As shown in FIG. 11, irrespective of the integrated or detachable type, an air inlet 131 can be connected, at one end, to the hollow area of the air-filled tube 130, and be exposed, at the other end, outside the wheel 100. Then, after a timer 1 is mounted on the wheel 100 of the present invention, compressed air can be injected into the air-filled tube 130 through the air inlet 131, so that a predetermined volume can be ensured by the air filling.

The safety wheel 100 of the present invention as set forth above is used in a state in which a conventional timer 1 is mounted thereto, in order to prevent a tire from being blown out and the vehicle from skidding out by centrifugal force in an unexpected incident during driving such as sudden lane change. If the tire is blown out, an assembly including the first rubber layer 120, the air-filled tube 130, the second rubber layer 140, the gauze member 160 and the rubber sheath 150, which are coupled with the protrusion 112 of the rim 110, acts as an emergency tire to support the weight of the vehicle while sustaining the pressure, so that the vehicle can continue to travel. Accordingly, the wheel 100 of the present invention can prevent the vehicle from rocking, becoming inclined or overturning, as well as enable emergency driving, thereby preventing a serious accident or casualties.

Furthermore, even if the tire is short of air, the safety wheel of the present invention provides pressure that can sustain the weight of the vehicle, thereby protecting the tire, and thus the wheel, from damage.

Moreover, the air pressure sensor 170 is mounted on the safety wheel 100, so that the driver can personally check the air pressure of the tire in order to maintain the air pressure constant at a predetermined level. The safety wheel 100 can also be provided with a bulletproofing function through the use of a bulletproof material.

According to the safety wheel for a vehicle of the present invention as set forth above, it is possible to ensure safe driving even if the tire is blown out or the air pressure is insufficient, and to prevent the tire from being blown out and the vehicle from skidding out due to centrifugal force.

The safety wheel of the present invention can be directly applied to industry fields for manufacturing general vehicle wheels, which use air pressure.

The safety wheel of the present invention can also be applied to industrial fields for manufacturing special wheels, which will be used for high speed driving and industrial transportation, or in specific situations that require a high level of safety.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A safety wheel for a vehicle, comprising:
a rim, having a body and a protrusion extending outward from an outer circumference of the body, the protrusion having a fastening groove;
a first rubber layer covered or wrapped on an outer portion of the protrusion of the rim to surround the protrusion;
an air-filled tube disposed on an outer central portion of the first rubber layer, the air-filled tube having a hollow body filled with compressed air therein;
a second rubber layer covered or wrapped on the protrusion of the rim, the first rubber layer and the air-filled tube; and
a rubber sheath covered or wrapped on the protrusion of the rim, the first rubber layer, the air-filled tube and the second rubber layer, thereby forming an outermost layer.

2. The safety wheel for a vehicle according to claim 1, further comprising a gauze member interposed between the second rubber layer and the rubber sheath in order to enhance a pressure-maintaining function.

3. The safety wheel for a vehicle according to claim 1, wherein the second rubber layer and the gauze member comprise a bulletproof material and have a bulletproofing function.

4. The safety wheel for a vehicle according to claim 1, wherein the air-filled tube comprises a rubber tube with a thread or a wire embedded therein, or a metal tube made of a metal material.

5. The safety wheel for a vehicle according to claim 1, further comprising an air pressure sensor mounted on an outer surface of the rubber sheath, thereby enabling a driver to identify air pressure of the tire that contacts the rubber sheath.

6. The safety wheel for a vehicle according to claim 2, wherein the second rubber layer and the gauze member comprise a bulletproof material and have a bulletproofing function.

7. A safety wheel for a vehicle, comprising:
a rim, having a body and a protrusion extending outward from an outer circumference of the body, the protrusion having a fastening element;
a tube disposed on an outer central portion of the protrusion, the tube having a hollow body that is filled with compressed air; and
an outer rubber layer covering the protrusion of the rim and the air-filled tube.

8. The safety wheel of claim 7, further comprising an intermediate rubber layer covering an outer portion of the protrusion of the rim to surround the protrusion intermediate the protrusion and the tube.

9. The safety wheel of claim 8, further comprising a rubber sheath covering the protrusion of the rim, the outer rubber layer, the tube and the intermediate rubber layer, thereby forming an outermost layer.

10. The safety wheel of claim 9, further comprising a gauze member interposed between the outer rubber layer and the rubber sheath in order to enhance a pressure-maintaining function.

11. The safety wheel of claim 9, further comprising an air pressure sensor mounted on an outer surface of the rubber sheath, thereby enabling a driver to identify air pressure of the tire that contacts the rubber sheath.

12. The safety wheel of claim 7, wherein the air-filled tube comprises a rubber tube with a thread or a wire embedded therein.

13. The safety wheel of claim 7, further comprising an air inlet coupled to the tube and exposed outside the wheel so that compressed air can be injected in the tube through the air inlet.

14. The safety wheel of claim 9, wherein the tube, the outer rubber layer, intermediate rubber layer and the rubber sheath are detachable from one another.
